(19) United States
(12) Patent Application Publication
(10) Pub. No.: US 2013/0194190 A1
(43) Pub. Date: Aug. 1, 2013

(54) DEVICE FOR TYPING AND INPUTTING SYMBOLS INTO PORTABLE COMMUNICATION MEANS

(71) Applicant: Alexey Lysenko, Ekaterinburg (RU)

(72) Inventor: Alexey Lysenko, Ekaterinburg (RU)

(73) Assignee: OCTODON LLC, Ekaterinburg (RU)

(21) Appl. No.: 13/698,972

(22) PCT Filed: Jun. 23, 2011
(86) PCT No.: PCT/RU2011/000447

§ 371 Date: Dec. 14, 2012

(30) Foreign Application Priority Data
Jul. 26, 2010 (RU) 2010131174

(51) Int. Cl. G06F 3/023

(52) U.S. Cl. CPC G06F 3/0234
USPC 345/169

(57) ABSTRACT

The device for typing and inputting symbols into portable communication means can be used in an application with communicators, pocket PCs, mobile telephones and other similar devices. The device comprises input elements in the form of keys under a user's finger, some of which keys are arranged on the rear side of the device body. The device is characterized in that each of the keys arranged on the rear side of the device body is intended for one finger only and is capable of registering four types of action by the finger: bending, unbending and shifting of the finger in two perpendicular directions. The device is aimed from the outset at direct typing rather than chorded typing, and has a large number of actions which can be carried out by fingers on the rear panel of the device, which should result in easier learning of typing and in more rapid typing.

### CROSS REFERENCE TO RELATED APPLICATION

This application is a U.S. National Phase of International Application No. PCT/RU2011/000447 filed on Jun. 23, 2011, which claims priority to and the benefit of Russian Patent Application No. 2010131174 filed on Jul. 26, 2010, the entire contents of which are incorporated herein by reference.

### BACKGROUND OF THE INVENTION

The present invention relates to the technical field of character data entry into portable digital devices such as communicators, handheld personal computers, mobile phones and similar devices. These devices are characterized by their small size, which prevents the placement of standard ergonomic QWERTY keyboards on such devices. These devices are further characterized by the necessity to hold the device while entering the characters, with the result that most of the operator's fingers are not involved in the character data entry most of the time. Because of these limitations, the text entry speed in modern portable devices is much lower than the entry speed using standard keyboards. Research and development of new devices for typing and entering character data, including text data, in order to overcome the above-mentioned limitations, is an urgent task.

Currently existing methods of entering information into portable devices can be divided into the following groups:
1. Entering information by using separate keys for each letter of the alphabet. This method is used, for example, in communicators with a miniature QWERTY keyboard.
2. Entering information by using keys, each of which corresponds to a set of characters. Each set of characters usually consists of three to five characters. A character is selected from the set by either repeatedly pressing the appropriate key, or by use software which selects the words by matching the typed sequence of characters with words selected from a dictionary. This method is mainly used in mobile phones. Entry speed by repeatedly pressing the keys is slower than the entry speed on devices with separate keys associated with each letter of the alphabet. When the dictionary method is used, the entry speed generally increases, but when the words are not present in the dictionary, the entry speed sharply decreases.
3. Entering information by using navigation keys and an on-screen displayed keyboard. This method is used in devices where text entry is rarely used, for example, in GPS receivers. This method is characterized by extremely low entry speed, because to enter one character, it is necessary to select the character on the screen by using the navigation keys and then to confirm the character selection.
4. [symbol] Chord [symbol] information input. The number of input elements is reduced by the inputting some (or all) characters of the alphabet by simultaneously pressing two keys.
5. Entering information using a touch-sensitive screen. This group includes information entry using a virtual keyboard and handwritten information entry with cursive writing recognition. When an onscreen virtual keyboard is used, the text is entered by using the fingertips (or by using a stylus). This method doesn't provide the user with any tactile feedback, and therefore makes blind typing impossible. Cursive writing, even on paper, is on average slower than information entry by using a standard keyboard, and requires good cursive writing for the text recognition software to work correctly.

Thus, the maximum text input speed can be achieved on the devices of the first group, where a separate key is designated for each character. Therefore, most portable devices used for active work with the text are provided with a miniature QWERTY keyboard, and the text is inputted by using the balls of the thumbs of both hands, while the other fingers hold the device from the back.

One of the promising ways to increase the text entry speed in portable devices involves using additional operator's fingers in the input process. The placement of the input elements on a compact portable device for comfortable input using additional fingers is a difficult task. Devices that are provided with a foldable QWERTY keyboard which is large enough for a 10-finger input are known in the art, but these devices requires a work surface to put the device on while inputting text.

Known solution for devices that need to be held during operation is back-typing—placement of input elements on the back side of the device, so that the fingers that are used for holding the device may also be used to input characters by interacting with raised input elements. The names of keyboards utilizing this principle, which are currently in production, are: keyboard Grippity1.0 by Grippity Ltd. (http://www.grippity.com), keyboard Twiddler by HandyKey, (http://www.handykey.com/), and keyboard AlphaGrip (iGrip) by AlphaGrip, Inc. (http://www.alphagrips.com).

Grippity1.0 is a transparent QWETRY keyboard, on which input elements are located on the back to be pressed by the index, middle, ring and little fingers of both hands. The device is held via ergonomic handles located on each side of the device, and the operator's thumbs are responsible for pressing the controls on the front side of the device.

The advantage of this approach is that input learning process is faster because of the usual arrangement of the input elements, even though mechanically the operator's hands operate in a different way than when typing on a standard keyboard. Among the factors which prevent achieving a higher speed input is the absence of the keyboard layout optimization, which would allow access to frequently used letters of the alphabet in the most convenient way, and would allow the entry of the combinations of most frequent pairs of characters in the quickest way possible. An attempt to optimize the keyboard layout will minimize an important advantage of the device—the ability to learn typing quickly.

Further development of the idea of locating the input elements on the back side of the device is the concept that fingers should be able to press the input elements by feel, without any visual control of their position. Devices of this kind don't need a transparent keyboard, and their front surface can be effectively used for placing a display with a larger diagonal dimension. In order to find the necessary input element on the back panel, software solutions are offered which utilize the display of animated symbols on a location on the screen that corresponds to the location of the input element on the back side of the device.

Blind-typing using input elements located on the back side of the device allows more efficient user actions when each finger controls a fixed set of the characters, and if the input keys are easy to find by touch, clear to distinguish, and located in such a manner that the movements of the fingers between the keys are minimal.

This concept is used by keyboard iGrip by AlphaGrip, Inc.

Some of the alphabet characters are located on the back side of the handles: four characters under each index finger, and two characters each under the little finger, the middle finger and the ring finger. The remaining letters of the alphabet, numeric keypad, and trackball are located on the front side of the device, and are controlled by the thumbs. In the iGrip keyboard layout, one can see the legacy of a QWERTY keyboard: characters on the back side of the device are located mainly in the area of action of fingers which are responsible for inputting these characters in a standard keyboard layout. It should be noted that in an Alpha PC device submitted to the Next-Gen PC Design 2008 competition, the keyboard layout was no longer associated with the QWERTY design, but was optimized for more comfortable input of the most frequently used characters and the most frequent combinations of pairs of characters. The presentation on the manufacturer's website shows that during input, the operator's fingers move rapidly between the pairs (quadruples) of controlled symbols. Thus an advanced user, using this type of an input device, can achieve entry speed comparable to the speed that can be achieved on a standard keyboard.

Device Twiddler2 by HandyKey (http://www.handykey.com/) is intended for one-handed text input using the “chord” method. 12 input keys are located on the back side of the device and 6 input keys—on the front side. Each character is typed by simultaneously pressing one or two keys. Unfortunately, there is no information about the entry speed of this device on the manufacturer's website. Most likely, the speed of entry for this devise is lower than the speed of entry for the keyboard AlphaGrip.

Closest to the claimed device is the device described in US 20100109915, published on Jun. 5, 2010. That device, and the method of symbol entry using that device, is based on the “chord” input method, and is implemented in an ergonomic form by a device which is held by both hands. On the back side of that device it is proposed to place eight two-position toggle switches, so that each finger, placed on the back side of the device, can provide two presses without moving. Together with the input mode selector under the thumb, this method allows to input 32 different characters, which is enough for the majority of alphabets. Also it is proposed to use a three-way momentary rocker switch, which can register a central downward press of the switch in addition to two sideways movements of the switch.

Thus, the device according to US 20100109915 is initially aimed at the “chord” input method rather than a direct input method, and therefore allows a limited number of operations by fingers on the back side of the device, and cannot provide easy to learn input and high typing speed.

### SUMMARY OF THE INVENTION

In the all known solutions of the problem of quick text input into portable devices, there are factors that prevent these solutions from being widely implemented. Grippity transparent keyboard concept seems to provide a lower typing speed for an experienced user than an ergonomic AlphaGrip keyboard, because using Grippity requires significant fingers movements, and for that type of devices, a QWERTY keyboard layout is not optimal for high speed typing. AlphaGrip has a great potential for increasing the typing speed. However, it is not in widespread use because of the dimensions of the device, which do not quite fit the idea of the form-factor of a modern portable device. The complex arrangement of the input elements (some of them are located on the front side of the device, and some of them are located on the back side) makes the process of learning high typing non-trivial.

The objective of this invention is to develop an ergonomic device, designed for direct character (text) input in portable devices, which would provide for text entry speed which is comparable to the text entry speed on a standard keyboard.

A vital factor for the device to succeed in the market is the simplicity and transparency of the typing learning process. Just after purchasing the device, the user should be able to input the text, maybe slowly, increasing the input speed while using the device, without spending time in special training or for memorization of input elements. If this demand is not met, the user is more likely to prefer a device with a mini-QWERTY keyboard.

The basis of the claimed invention is the development of input elements and the arrangement of input elements on the body of the portable device in a way that would make the device comfortable to hold, and would also make the input elements easy to reach for comfortable blind typing. More detailed development of the device offers the most appropriate design of the body of the device, an optimal keyboard layout, and also proposals for the device's user interface, which would allows the user to input text immediately without initial training.

### DETAILED DESCRIPTION

### Way to Solve the Problem

### Mechanics

In order to increase the user's confidence when blind typing, it is suggested to use one finger for each input element located on the backside of the device. While typing, the finger should not lose contact with the input element, and the movements of the finger in different directions should correspond to the input of different characters. This solution allows more confident blind typing and a more secure grip on the device because there is no need to move the fingers between the input elements. It should be noted that too many possible directions of moving each input element will result in an increased number of typos because of the difficulties with selecting the exact angle of a finger movement.

The practice showed that four directions: bending the finger, unbending the finger, and shifting the finger in two directions perpendicular to the direction of bending and unbending, are clear to distinguish and easy to implement. Therefore, it is proposed to place input elements similar in principle of operation to five-way joysticks on the back side of the device. These joysticks are used in some mobile phones, and can register four different sideways movements and a central downward press. For convenience of controlling input elements with one finger, ergonomic overlays allowing easy movement of the input elements are provided for each input element.

When holding the device, the balls of the thumbs of both hands are located on the front side of the device and are able to operate a number of visible input elements located in such a way that access to them does not require grasping the device. Among the input elements located on the front of the device there can also be multi-way input elements.

For a sure grip of the device, a sufficient width of the device is required, since during typing the device is held mostly by its sides in the palms of the hands of the user. The size of modern communicators is usually insufficient for comfortable holding with both hands, so it makes sense to consider variants of devices that include parts that unfold or slide apart—in order to achieve more comfortable holding when typing.

To simplify learning to type, it is suggested to design all input elements responsible for the alphabetic character input on the same (back) side of the device. For the same purpose, it is suggested to use a single type of finger movement (directional displacements of the input elements) for input of alphabetic characters, because it requires different efforts to produce polytypic actions such as “inclination” and “pressing”, and the need to calibrate efforts could slow down the text entry speed and increase the number of typos.

In contrast to the device of US 20100109915, the claimed device is initially aimed at the direct input method rather than the “chord” input method and allows more input actions, produced by the fingers on the backside of the device, that should provide easy to learn input and high typing speed.

### Layout

In order to increase the text entry speed to its potential maximum, the device requires the development of an optimal keyboard layout. Fingers have different physiological characteristics. A layout that takes this fact into account can provide a significant increase of the input speed, if more convenient finger movements and sequences of finger movements correspond to the input of more common characters and more common character sequences. As finger movements on the back side of the device are not all equally convenient to the operator, the most frequently used alphabet characters should be located at the input keys/areas of keys that are the most convenient for pressing. Analysis of the frequency of paired combinations of letters in texts can be used to speed up typing of the most frequent combinations of pairs of letters.

When placing eight four-way or five-way input elements on the back side (underside) of the device, 32 possible displacements of input keys are registered in total. This is enough to present the Russian alphabet (without the letter <\ddot{R}>) or any European alphabet, so there is no problem with the localization of the layout.

The most frequent non-alphanumeric characters and the “enter” key, the “shift” key and the text editing keys can be located under the thumbs and can use the directions of key displacements which are not used for entry of alphanumeric characters. Rarely used characters can be inputted, for example, by calling up a character selection window on the touch screen of the mobile device.

### Interface

To be able to learn to input while using the device, the user needs information about which finger to move in which direction on the backside of the device to input one or another character. Absence of a need to identify input elements by touch allows the creation of schematic interfaces that don't need to copy the input elements' location on the backside of the device. Display of eight groups of four characters, approximately corresponding to where the input elements are located on the backside, significantly increases text entry speed, especially if the display is animated.

In order to stimulate layout memorization, a “tip” box can be used which would become more transparent up to almost complete disappearance depending on the text entry speed. This should encourage the user to make finger movements mechanically before his or her eyes begin to look for the character's position in the “tip” box, which appears as soon as the operator pauses while entering text.

Today, stereo image formation techniques are becoming increasingly popular and, in particular, prototypes of stereo displays for mobile devices are already known. On such a display, an animated tip box with labeled key layout can be displayed at a plane above the screen with the inputted text, which would allow the user to switch his or her attention from one display to another in a more quick and comfortable manner.

### BRIEF DESCRIPTION OF THE DRAWINGS

The claimed invention is illustrated by the following drawings:

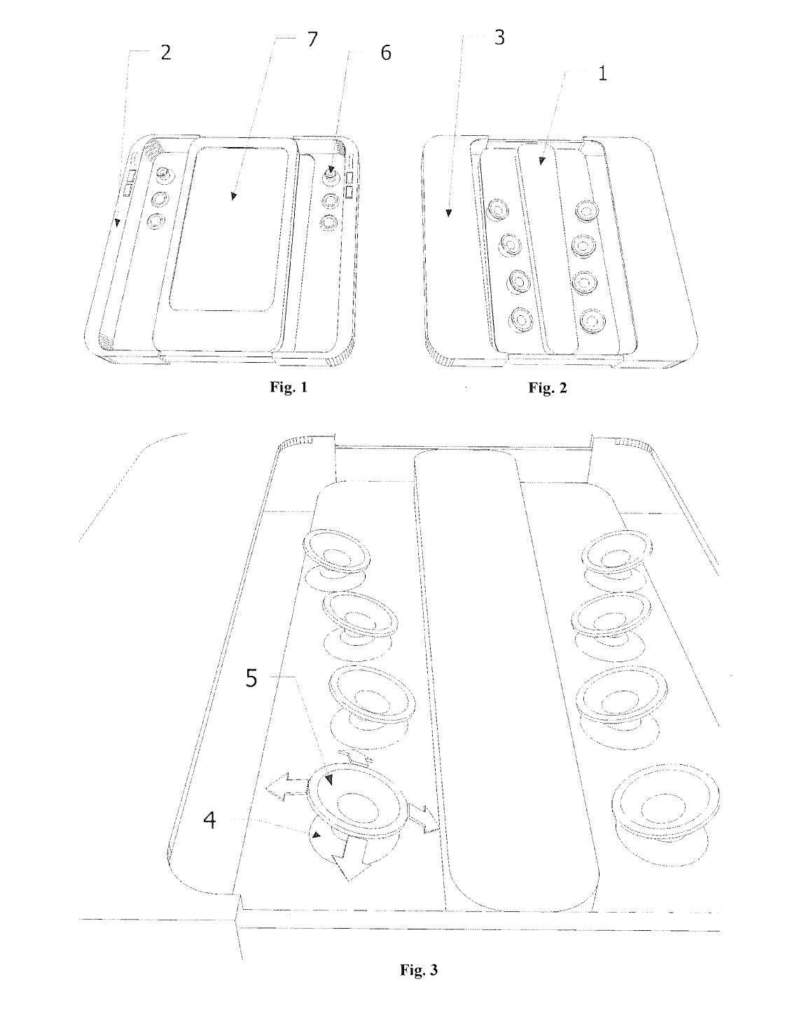

The device's front side is presented in FIG. 1;

The device's back side is presented in FIG. 2;

The input elements with ergonomic overlays are presented in FIG. 3;

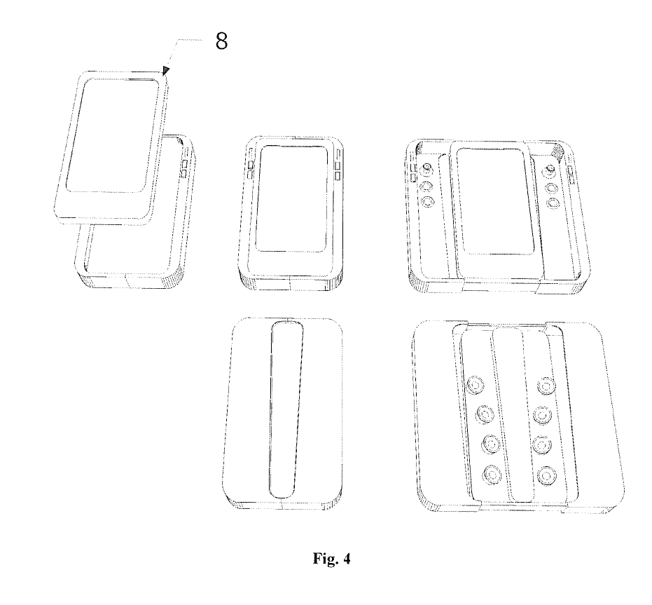

The implementation of the device as a connectable module, and the possibilities of the device body's transformation are presented on FIG. 4;

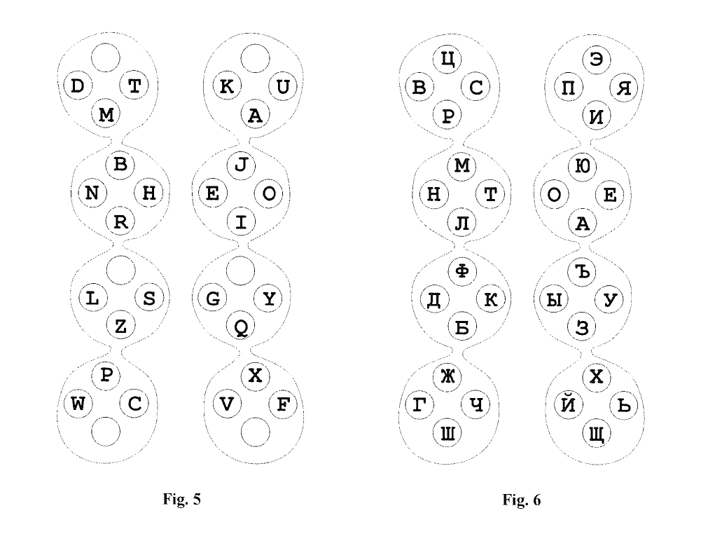

The English keyboard layout is presented in FIG. 5; and

The Russian keyboard layout is presented in FIG. 6.

The claimed invention is also illustrated by the following photographs:

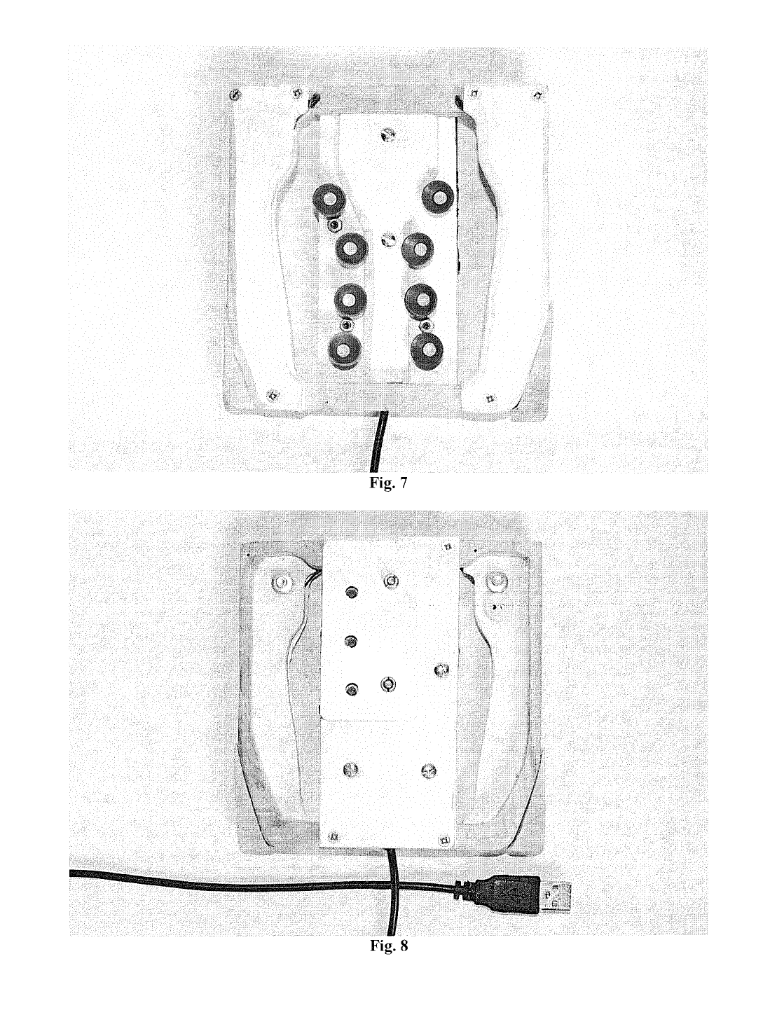

The prototype device's back view is shown in FIG. 7;

The prototype device's front view is shown in FIG. 8; and

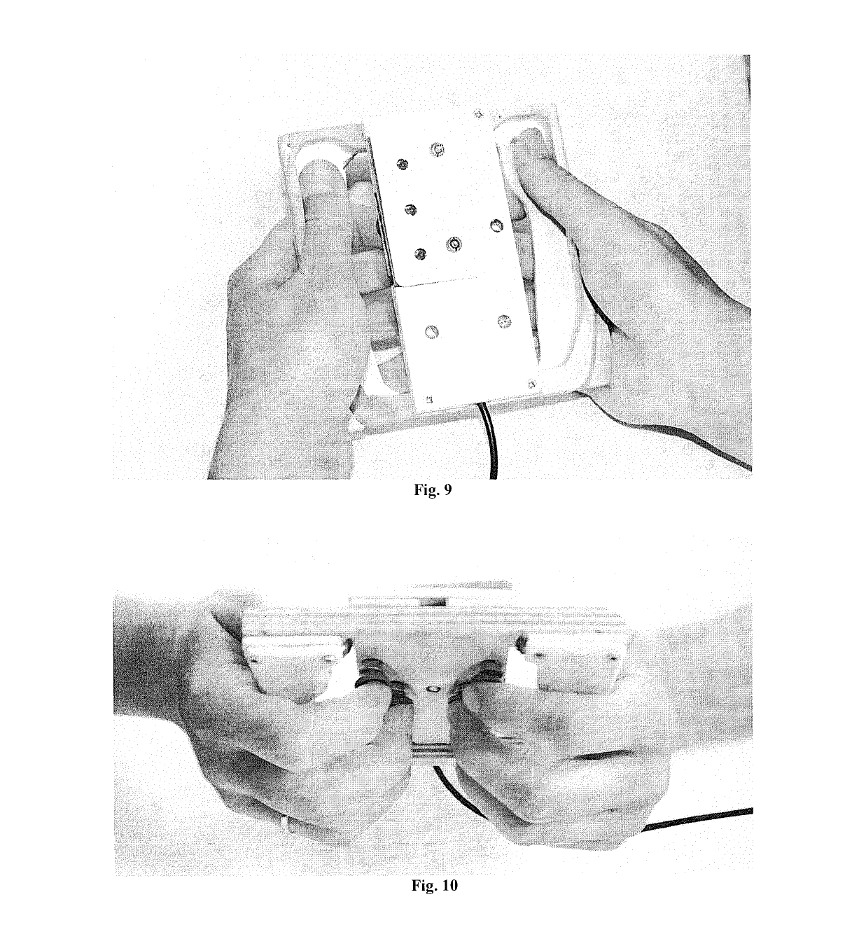

The prototype device in the user's hands is shown in FIGS. 9 and 10.

The device body 1 (FIG. 2) is designed in such a way that a folded device has the dimensions that are similar to the size of modern communicators: length—12 cm, width—6 cm. The thickness of the device should not exceed reasonable limits. A large touch screen is located on the front side of the device.

For more comfortable holding of a small-sized device with both hands, the device is made with extendable (by 3 cm) handles 2 (FIG. 1) on each side. When the device is put into a working configuration for text input, back cover 3 (FIG. 2) of the device, which is divided vertically into two parts, slides apart. The width of the device increases up to 12 cm, which allows the device to be held comfortably with both hands. Under the back cover of the device, eight four-way input elements (joysticks) 4 with ergonomic overlays 5 are located (FIG. 3). Two more five-way joysticks 6 (FIG. 1) for the thumbs and other input elements, operation of which can be controlled visually, are located on the inner sides of the movable halves of the back cover, said inner sides of the movable halves of the back cover being located on the sides of the screen and facing the user when in an open position.

The central front part of the device does not contain any input elements. A large touch screen 7 (FIG. 1) may be located on the central front part of the device, where the tips about the input elements on the back-side can be displayed, and with the help of which the input of rarely used and special characters can be accomplished. The embodiment of the device as a module, attached to a keyboard-less communications means 8, is also possible (FIG. 4). In this case the communication means 8 are attached to the rear panel of the device which does not contain input elements. This embodiment is shown in FIG. 4.

The experimental model of the keyboard is based on a standard 104-keys USB-keyboard controller. Commercially produced joysticks from cell phones were used as input elements on the back side of the device. English and Russian keyboard layouts were prepared. To form these layouts, all 32 different directions of displacement of the input elements were assigned degrees of pressing ease. More frequently-used alphabet characters were placed at the areas of displacement of the input elements that are more convenient for pressing. The least suitable areas were left free of letters (for the English keyboard layout) and are intended to be used for special characters. Analysis of the frequency of paired letters combinations in the texts was used to place characters on the layout in such a manner so that the most frequent combinations of pairs of letters are to be inputted by successive movements of the fingers of the right and left hands, requiring as little as possible sequential inputting of letters by movement of the same finger.

Areas of displacements of the joystick controlled by right hand thumb are allocated as follows:
Right—space; (hold Shift—dash);
Left—Backspace;
Up—comma (hold Shift—the exclamation mark);
Down—period (hold Shift—the question mark).

The Enter key is located below the joystick of the right hand. It is also possible to place the Enter key so that it is activated by the central downward press of the joystick.

Areas of displacements of the joystick controlled by left hand thumb are allocated as follows:
Right—Delete;
Left—a colon;
Up—a semicolon;
Down—Shift.

For the English keyboard layout, joystick movements on the back side of the device which are not associated with any alphabet letters (upward movements of the index and ring fingers and the downward movements of the little fingers) are associated with the symbols for apostrophe, brackets, and quotation marks.

The device was tested on a personal computer. For test purposes, the designed layouts have been implemented using the Microsoft Keyboard Layout Creator 1.4. For the convenience of typing training, an application was created that displays on the screen a window image of eight groups of characters, corresponding to the joysticks movements on the back side of the device. When pressing the joystick is pressed, the appropriate character on the screen is illuminated. This allows the user to type the text, looking just at the screen, and in time detecting typing mistakes in time.

What is claimed:

1. A device for typing and inputting characters into a portable communication means, comprising input elements in the form of keys for user's fingers, wherein at least some of said keys are located on the back side of the device and are intended for use by only one finger and can register four finger movements: bending the finger, unbending the finger, and shifting the finger in two perpendicular directions.

2. The device of claim 1, wherein the keys on the back side of the device are located in two rows of four keys, and the four keys of the first row are intended for the index finger, the middle finger, the ring finger and the little finger of the user's right hand, and the four keys of the second row are intended for the index finger, the middle finger, the ring finger and the little finger of the user's left hand.

3. The device of claim 1, wherein the input elements located on the front side operate analogously to the input elements located on the back side of the device.

4. The device of claim 1, wherein the input elements located on the back side of the device comprise eight four- or five-way joysticks.

5. The device of claim 1, wherein the input elements include overlays for contact with the user's fingertips.

6. The device of claim 1, wherein the back side of the body of the device is expandable.

7. The device of claim 6, wherein the input elements intended for the user's thumbs are located on the front surface of the expandable parts of the device.

8. The device of claim 1, wherein the device is provided with a display screen on which alphabetic characters are shown so that a character's location on the display screen corresponds to the character's location on the input elements on the back side of the device.

9. The device of claim 1, wherein the device is connectable to a communication means so that the keys on the back side of the device are located beyond the display screen of the connected communication means.
